(19) United States
(12) Patent Application Publication
(10) Pub. No.: US 2019/0007286 A1
(43) Pub. Date: Jan. 3, 2019

(54) MODULE FOR HANDLING A STREAM OF DATA OVER MULTIPLE WIRELESS COMMUNICATION CHANNELS

(71) Applicant: DeviceRadio AB, Helsingborg (SE)

(72) Inventor: Christian KLEMETSSON, Helsingborg (SE)

(21) Appl. No.: 16/023,329

(22) Filed: Jun. 29, 2018

Related U.S. Application Data
(63) Continuation of application No. PCT/SE2018/050707, filed on Jun. 28, 2018.

(30) Foreign Application Priority Data
Jun. 30, 2017 (SE) 1750864-9

(51) Int. Cl. H04L 12/26

(52) U.S. Cl. CPC H04L 43/08

(57) ABSTRACT

The disclosure relates to a data stream handler module configured to cause transmission and/or reception of a single or multiple streams of data over multiple wired and/or wireless communication channels between a hardware unit and a software application comprised in a remote communication device.

### RELATED APPLICATION DATA

This application claims the benefit of Swedish Patent Application No. 1750864-9 filed Jun. 30, 2017 and International Patent Application No. PCT/SE2018/050707 filed Jun. 28, 2018, the disclosures of which are incorporated herein by reference in their entireties.

### TECHNICAL FIELD

The present disclosure relates to field of handling streams of data. More particular the invention pertains to a module for adding connectivity to otherwise non-connected devices and software applications or services included in remote communication devices.

### BACKGROUND ART

Today, there is an increasing development in connectivity technologies, e.g. Internet-of-things, IoT, which leads to numerous connectivity related software based services and applications. To be able to use these services and applications there is a need for adding connectivity to existing non-connected devices. Accordingly, in order to implement an appropriate communication framework and add connectivity to the non-connected devices, a manufacturer or developer of non-connected devices has to learn how to implement the communication framework and define relevant services, applications, configurations, methods and logic associated with the communication framework which is a tedious and error-prone process.

### SUMMARY OF THE INVENTION

An object of the present disclosure is to provide a module and system for adding connectivity between non-connected devices and services or applications, which method and system seek to mitigate, alleviate or eliminate one or more of the above-identified deficiencies in the art and disadvantages singly or in any combination.

The present disclosure is defined by the appended claims. Various advantageous embodiments of the disclosure are set forth by the appended claims as well as by the following description and the accompanying drawings.

The term “data” as used herein is for the purpose of describing aspects of the disclosure only and is not intended to limit the disclosure. As used herein, the general term data includes “data packages” wherein a data package is a simple container format used to describe and package a collection of data.

The object is obtained by a module for handling a stream of data configured to cause and/or control transmission of a single stream of data over multiple wired and/or wireless communication channels between a hardware unit and a software application comprised in a remote communication device, wherein the module comprises a multiplexor configured to split the single stream of data into multiple streams of data (e.g. based on instructions from a processor), wherein each of the multiple streams of data is a subset or an exact or a complete copy of the single stream of data and a processor configured to cause and/or control transmission of the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected (e.g. based on instructions from the processor) to carry the stream of data depending on the monitored quality or a predicted quality (e.g. a prediction of quality can be based on previously monitored data with similar prerequisites) of the at least two different wired and/or wireless communication channels wherein the monitoring of quality comprises monitoring signal strength, packet loss, transmission speed, jitter or latency.

The object is obtained by a module for handling a stream of data configured to cause and/or control transmission of a single stream of data over multiple wired and/or wireless communication channels between a hardware unit and a software application comprised in a remote communication device and reception of multiple streams of data over multiple wired and/or wireless communication channels between a hardware unit and a software application comprised in a remote communication device, wherein the module comprises a multiplexor configured to split the single stream of data to be transmitted into multiple streams of data (e.g. based on instructions from a processor), wherein each of the multiple streams of data is a subset or an exact or a complete copy of the single stream of data and a demultiplexor configured to assemble the received multiple streams of data into one single stream of data. The processor is configured to cause and/or control transmission of the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies and to cause reception of the multiple streams of data over at least two different wired and/or wireless communication channels at the same time, wherein each of the multiple streams of data is received over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected (e.g. based on instructions from the processor) to carry the stream of data depending on the monitored quality or a predicted quality of the at least two different wired and/or wireless communication channels wherein the monitoring of quality comprises monitoring signal strength, packet loss, transmission speed, jitter or latency.

The object is obtained by a module for handling a stream of data wherein a multiplexor is further configured to set a time stamp on each data package and wherein the demultiplexor is further configured to read the time stamp on each data package in order to determine latency or jitter. Latency (i.e. data packet loss) and jitter (i.e. variation in latency) are two quality parameters which are determined and monitored continuously on the different wired and/or wireless communication channels.

The object is obtained by a module for handling a stream of data packages wherein a processor is further configured to cause an information exchange with another processor of another data stream handler module and wherein the information exchange comprises monitoring information on quality of at least two different wired and/or wireless communication channels.

The object is obtained by a server for handling multiple streams of data over at least two different wired and/or wireless communication channels at the same time configured to receive the multiple streams of data, wherein each one of the multiple streams of data is a subset or an exact or a complete copy of a single stream of data, analyse the availability for transmission of at least one of the multiple streams of data over each one of the different wired and/or wireless communication channels, select at least two different wired and/or wireless communication channels which are determined as available, transmit each of the received streams of data over the selected at least two different wired and/or wireless communication channels, wherein each of the multiple streams of data is transmitted over a corresponding one of the at least two different wired and/or wireless communication channels wherein each different wired and/or wireless communication channel is configured according to different data transmitting technologies. The at least two different wired and/or wireless communication channels are continuously monitored on quality and selected/re-selected (e.g. based on instructions from a processor) to carry the stream of data depending on the monitored quality or a predicted quality of the at least two different wired and/or wireless communication channels wherein the monitoring of quality comprises monitoring signal strength, packet loss, transmission speed, jitter or latency.

The object is obtained by a server wherein the server is further configured to comprise a module comprising multiplexors/demultiplexors and processor.

The object is obtained by a computer program product comprising a non-transitory computer readable medium, having thereon a computer program comprising program instructions, the computer program being loadable into a data processing unit configured to, when the computer program is run by the data processing unit, cause execution of the steps of splitting a single stream of data into multiple streams of data (e.g. based on instructions from a processor), wherein each of the multiple streams of data is a subset or an exact or a complete copy of the single stream of data and transmitting the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected (e.g. based on instructions from the processor) to carry the stream of data depending on the monitored quality or a predicted quality of the at least two different wired and/or wireless communication channels wherein the monitoring of quality comprises monitoring signal strength, packet loss, transmission speed, jitter or latency.

The object is obtained by a computer program product comprising a non-transitory computer readable medium, having thereon a computer program comprising program instructions, the computer program being loadable into a data processing unit configured to, when the computer program is run by the data processing unit, cause execution of the steps of receiving a multiple streams of data over at least two different wired and/or wireless communication channels at the same time, wherein each of the multiple streams of data is received over a corresponding one of the at least two different wired and/or wireless communication channels and wherein each of the at least two different wired and/or wireless communication channels are configured according to different data transmitting technologies and assembling the multiple streams of data into one single stream of data (e.g. based on instructions from a processor), wherein each of the multiple streams of data is a subset or an exact or a complete copy of the single stream of data. The at least two different wired and/or wireless communication channels are continuously monitored on quality and selected/re-selected (e.g. based on instructions from the processor) to carry the stream of data depending on the monitored quality or a predicted quality of the at least two different wired and/or wireless communication channels wherein the monitoring of quality comprises monitoring signal strength, packet loss, transmission speed, jitter or latency.

The object is obtained by a computer program product comprising a non-transitory computer readable medium, having thereon a computer program comprising program instructions, the computer program being loadable into a data processing unit configured to, when the computer program is run by the data processing unit, cause execution of the steps of receiving a multiple streams of data (e.g. based on instructions from a processor), wherein each one of the multiple streams of data is a subset or an exact or a complete copy of a single stream of data, analysing an availability for transmission of at least one of the multiple streams of data over each one of the different wired and/or wireless communication channels, selecting at least two different wired and/or wireless communication channels which are determined as available and transmitting each of the received multiple streams of data over the selected at least two different wired and/or wireless communication channels, wherein each of the multiple streams of data is transmitted over a corresponding one of the at least two different wired and/or wireless communication channels wherein each different wired and/or wireless communication channel is configured according to different data transmitting technologies. The at least two different wired and/or wireless communication channels are continuously monitored on quality and selected/re-selected (e.g. based on instructions from the processor) to carry the stream of data depending on the monitored quality or a predicted quality of the at least two different wired and/or wireless communication channels wherein the monitoring of quality comprises monitoring signal strength, packet loss, transmission speed, jitter or latency.

The object is obtained by a module for handling a stream of data configured to cause reception of multiple streams of data over multiple wired and/or wireless communication channels between a hardware unit and a software application comprised in a remote communication device, wherein the module comprises a processor configured to cause reception of the multiple streams of data over at least two different wired and/or wireless communication channels at the same time (e.g. based on instructions from the processor), wherein each of the multiple streams of data is received over a corresponding one of the at least two different wired and/or wireless communication channels and wherein each of the at least two different wired and/or wireless communication channels are configured according to different data transmitting technologies and a demultiplexor configured to assemble the multiple streams of data into one single stream of data, wherein each of the multiple streams of data is a subset or an exact or a complete copy of the single stream of data. The at least two different wired and/or wireless communication channels are continuously monitored on quality and selected/re-selected (e.g. based on instructions from the processor) to carry the stream of data depending on the monitored quality or a predicted quality of the at least two different wired and/or wireless communication channels wherein the monitoring of quality comprises monitoring signal strength, packet loss, transmission speed, jitter or latency.

An advantage of the present disclosure is that a high-level (e.g. uniform) connectivity infrastructure that bridges hardware, HW, with remote software applications is provided. A further advantage is to provide a (e.g. seamless) connectivity infrastructure that works with existing solutions (i.e. compatible with existing solutions) and bridges HW with software, SW in an intuitive way (i.e. in a robust and efficient way with respect to the actual and predicted capabilities of each separate connectivity channel).

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an example of a module and system according to the present disclosure;

FIG. 2 illustrates an example of a module and system according to the present disclosure;

FIG. 3 illustrates an example of a module and system according to the present disclosure;

FIG. 4 illustrates an example of a module and system according to the present disclosure;

FIG. 5A-C illustrates an example of a computer program product according to the present disclosure.

### DETAILED DESCRIPTION

Aspects of the present disclosure will be described more fully hereinafter with reference to the accompanying drawings. The system, method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some of the example embodiments presented herein are directed towards a module for handling streams of data. The disclosure relates to a module and server for adding connectivity to non-connected HW and software services or applications. As part of the development of the example embodiments presented herein, a problem will first be identified and discussed. Today many producers and manufactures of all kinds of HW, such as camera, cars, doors, kitchen aids among others (e.g. potential Internet of Things devices) wish to connect the HW with software services and applications but do not have the knowledge regarding how to implement this (i.e. functionality) in their products. Accordingly, in order to implement an appropriate communication framework and add connectivity to the non-connected devices, the manufacturer or developer has to learn how to implement the communication framework and define relevant services, applications, configurations, methods and logic associated with the communication framework which is a tedious and error-prone process.

The present disclosure provides a (e.g. agnostic) solution for connecting non-connected devices, HW, with services and applications by providing a module and a server for transmitting and receiving streams of data between HW and software services and applications without them knowing anything about each other.

The modules enable users of the HW to access software applications, e.g. Application Programming Interfaces, APIs. The modules can be connected to external sensors and Integrated Circuits, ICs. The modules access to APIs allows its users to use a range of web technologies, including Representational State Transfer, REST, JavaScript Object Notation, JSON, MessagePack, Streaming Text Oriented Messaging Protocol, STOMP, WebSockets, OAuth and OpenID connect.

The provided module and server makes the HW smart by adding connectivity such that communication over the Internet is enabled and make the HW available in a software application or service. The provided module enables the user to user their favourite language (e.g. a programming language), to read and write to the HW instantly in real time just as if they would have direct access to the HW.

One example is a driverless car (i.e. an autonomous car) that is wirelessly connected to a remote monitoring station by connecting a data stream handler module according to the present disclosure to the driverless car and the remote monitoring station for e.g. streaming video from the driverless car to the remote monitoring station.

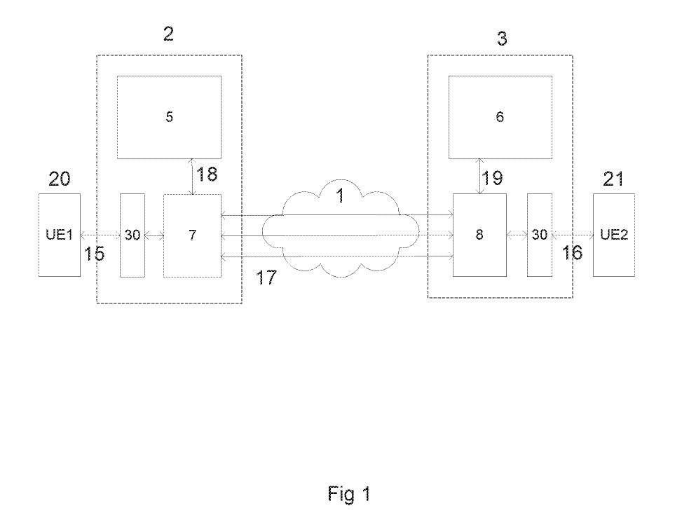

FIGS. 1-4 disclose a data stream handler module 2, 3 configured to cause and/or control transmission of a single stream of data over multiple wired and/or wireless communication channels between a hardware unit 20 and a software application comprised in a remote communication device 21.

In one aspect the module is a separate unit connected, wireless or with wire, to respective hardware 20 and software application comprised in the remote communication device 21. A hardware unit could be a sensor, a camera, cars, doors, kitchen aids among others (e.g. potential Internet of Things devices). A software application could be web-based tool for presenting a temperature measured by sensor i.e. hardware unit. A remote communication device could be a smartphone, mobile phone, tablet, computer among others.

In one aspect, the hardware 20 does not know anything about the software application comprised in the remote communication device 21.

In one aspect, the module 2, 3 comprises a multiplexor 7, 8 configured to split a single stream of data into multiple streams of data, wherein each of the multiple streams of data is a subset or an exactor a complete copy of the single stream of data. The module 2, 3 further comprises a processor, e.g. including a software library, configured to cause and/or control transmission of the multiple streams of data over at least two different wired and/or wireless communication channels 13, 17 at the same time, wherein each of the multiple streams of data is transmitted over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency. Examples wherein continuous monitoring of quality is especially useful comprises remote control of vehicles (e.g. driving) or drones (e.g. flying) and other devices configured for Machine Critical Communication (e.g. device-to-device communication). The continuous monitoring of quality is further especially useful for real time remote control of industrial machines such as robot arms and power steering motors i.e. devices configured for Machine Critical Communication. In one embodiment, as shown in FIGS. 1-4, a data stream handler module 2, 3 is provided, which is configured to cause reception of multiple streams of data 13, 17 over multiple wired and/or wireless communication channels between a hardware unit 20 and a software application comprised in a remote communication device 21.

In one aspect, the module 2, 3 comprises a processor, e.g. including a software library, 5, 6, configured to cause reception of multiple streams of data over at least two different wired and/or wireless communication channels 13, 17 at the same time, wherein each of the multiple streams of data is received over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency. The module 2, 3, further comprises a demultiplexor configured to assemble the multiple streams of data into one single stream of data, wherein each of the multiple streams of data is a subset or an exact or a complete copy of the single stream of data.

In one embodiment, as shown in FIGS. 1-4 discloses, a data stream handler module 2, 3 which is configured to cause and/or control transmission of a single stream of data over multiple wired and/or wireless communication channels and reception of multiple streams of data 13, 17 over multiple wired and/or wireless communication channels between a hardware unit 20 and a software application comprised in a remote communication device 21.

In one aspect, the module 2, 3 comprises a multiplexor 7, 8 configured to split the single stream of data to be transmitted into multiple streams of data, wherein each of the multiple streams of data is a subset of or an exact or a complete copy of the single stream of data. The module 2, 3, comprises a demultiplexor configured to assemble the received multiple streams of data into one single stream of data, wherein each of the multiple streams of data is a subset or an exact or a complete copy of the single stream of data. The module comprises a processor 5, 6, e.g. including a software library, configured to cause and/or control transmission of the multiple streams of data over at least two different wired and/or wireless communication channels 13, 17 at the same time, wherein each of the multiple streams of data is transmitted over a corresponding one of the at least two different wired and/or wireless communication channels and wherein each of the at least two different wired and/or wireless communication channels are configured according to different data transmitting technologies. The processor is configured to cause reception of the multiple streams of data over at least two different wired and/or wireless communication channels 13, 17 at the same time, wherein each of the multiple streams of data is received over a corresponding one of the at least two different wired and/or wireless communication channels and wherein each of the at least two different wired and/or wireless communication channels are configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

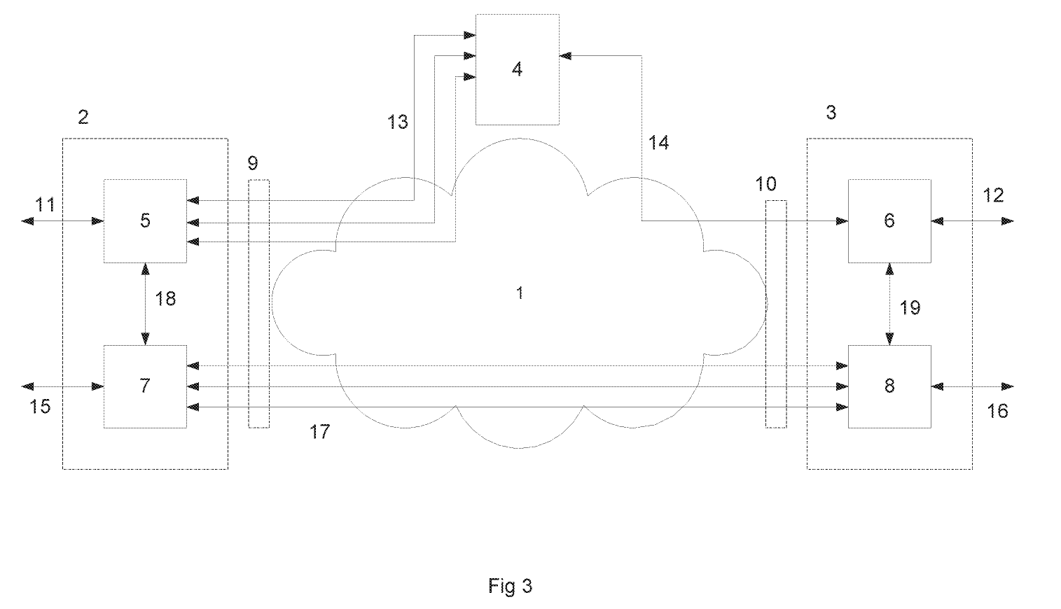

In one aspect, e.g. according to FIG. 3, the connections, denoted by 11, 12, 15 and 16, between the module 2, 3 and the hardware unit 20 or remote communication device 21 may be IP-based, for example WiFi, cellular data or broadband.

In one aspect, not shown, the module 2, 3 is included in the hardware unit 20.

In one aspect, not shown, the module 2, 3 is included in the remote communication device 21.

In one aspect, not shown, the module 2, 3 is included in the hardware unit 20 and in the remote communication device 21.

In one aspect, not shown, the module 2, 3 is included in a server or router 4.

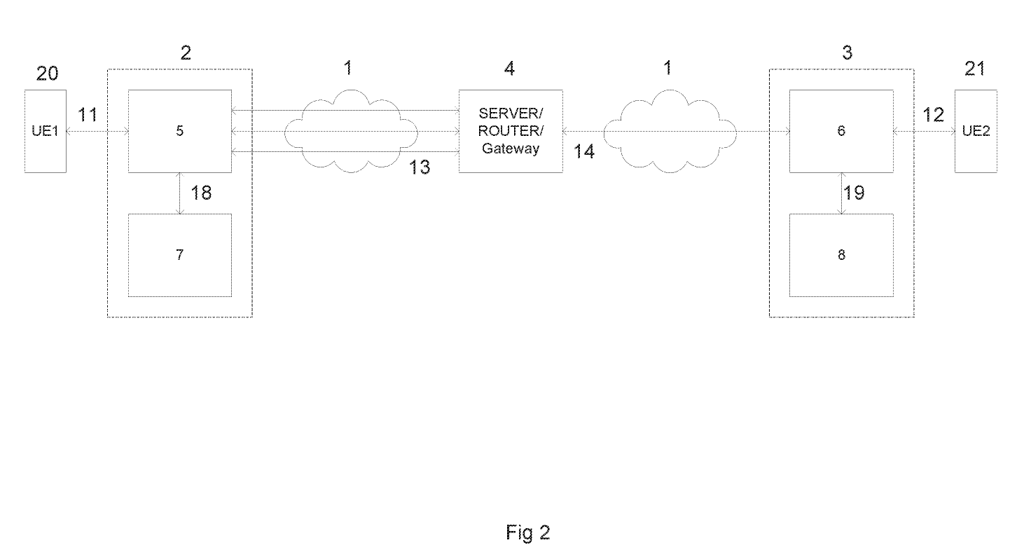

FIGS. 2-4 discloses a server or router 4 for handling multiple streams of data over at least two different wired and/or wireless communication channels 13 at the same time. The server is configured to receive the multiple streams of data, wherein each one of the multiple streams of data is a subset or an exact or a complete copy of a single stream 11, to analyse the availability for transmission of at least one of the multiple streams of data over each one of the different wired and/or wireless communication channels 13, to select at least two different wired and/or wireless communication channels 13 which are determined as available, to transmit each of the received streams of data over the selected at least two different wired and/or wireless communication channels 13, wherein each of the multiple streams of data is transmitted over a corresponding one of the at least two different wired and/or wireless communication channels. Each different wired and/or wireless communication channel is configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

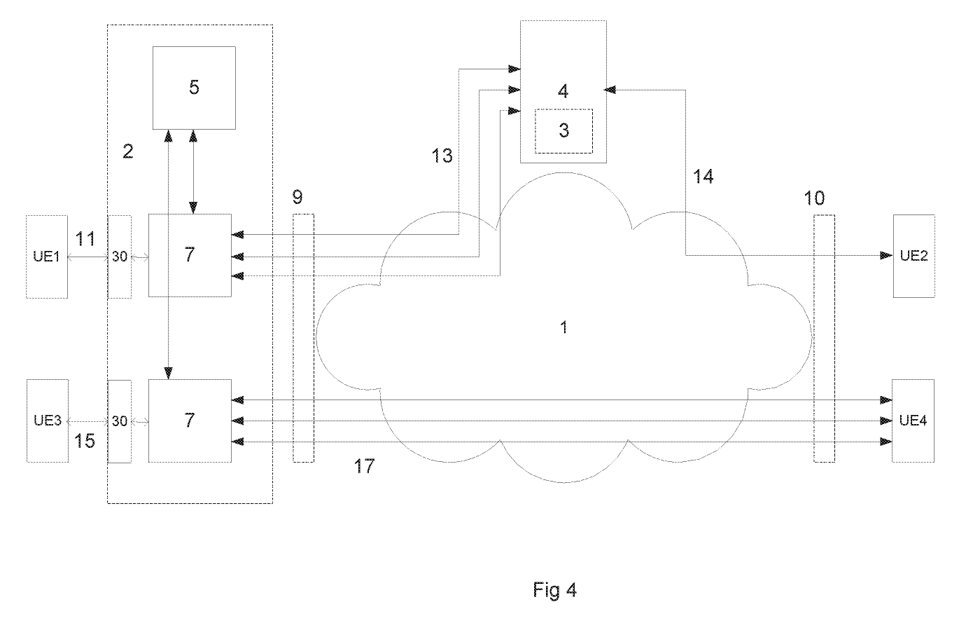

FIG. 4 discloses a server or router 4 for handling multiple streams of data over at least two different wired and/or wireless communication channels 13 at the same time. The server 4 comprising module 3 is configured to receive the multiple streams of data, wherein each one of the multiple streams of data is a subset or an exact or a complete copy of a single stream 11, to analyse the availability for transmission of at least one of the multiple streams of data over each one of the different wired and/or wireless communication channels 13, to select at least two different wired and/or wireless communication channels 13 which are determined as available, to transmit each of the received streams of data over the selected at least two different wired and/or wireless communication channels 13, wherein each of the multiple streams of data is transmitted over a corresponding one of the at least two different wired and/or wireless communication channels. Each different wired and/or wireless communication channel is configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

In one aspect, the at least one of the data transmitting technologies comprises radio access technology defined in accordance with a radio access technology standard.

In one aspect, the radio access technology is any of 5G, 4G, LoRa, Low-Power Wide-Area Network, LPWAN, Bluetooth, SMS, Elliptic Curve Cryptography, ECC, Secure Hash Algorithm 2, SHA-2, Secure Hash Algorithm 3, SHA-3, among others.

The server or router 4 may act as a bridge between a hardware unit 20 connected to a module 2, 3, a connected hardware unit, and a software application comprised in a remote communication device 21, connected to a module 2, 3, a connected software application. The connected hardware unit and the connected software applications do not need to know the physical location of each other. In one example, the server 4 may act as a bridge between one connected hardware unit 20 and one or more connected software applications 21. In one example, the server 4 may act as a bridge between one connected software application 21 and one or more connected hardware units 20.

The server or router 4 comprising module 3 further comprising multiplexors/demultiplexors 8 (not shown) may act as a bridge between a hardware unit 20 (i.e. UE1) connected to module 2 comprising multiplexors/demultiplexors 7 and a software application comprised in a remote communication device 21 (i.e. UE2). The multiplexors/demultiplexors 7 are configured to split corresponding single stream of data into multiple streams of data and to assemble the multiple streams of data into one single stream of data, wherein each of the multiple streams of data is a subset or an exact or a complete copy of one the single stream of data. The modules 2,3 further comprises a processor 5 configured to cause and/or control transmission of the multiple streams of data over at least two different wired and/or wireless communication channels 13, 17 at the same time, wherein each of the multiple streams of data is transmitted over a corresponding one of the at least two different wired and/or wireless communication channels and wherein each of the at least two different wired and/or wireless communication channels are configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency. The modules 2, 3 further also comprise communication interfaces 30, as shown in FIG. 4 for module 2, configured to communicate with at least one remote entity over a communication network 1. The server 4 learns (i.e. learns based on quality measurements and service quality requirements) about the different ways the connected hardware connects with the connected software application and the server 4 can use this information to optimize and coordinate connections directly, denoted by 17 e.g. in FIG. 3 and FIG. 4, between the connected hardware unit and the connected software applications (i.e. a peer to peer communication for capacity demanding applications which require peer to peer to keep up speed and throughput with minimum or no overhead, denoted by 17 in FIGS. 3 and 4, in parallel with the server based communication, denoted by 13, 14 in FIGS. 3 and 4.).

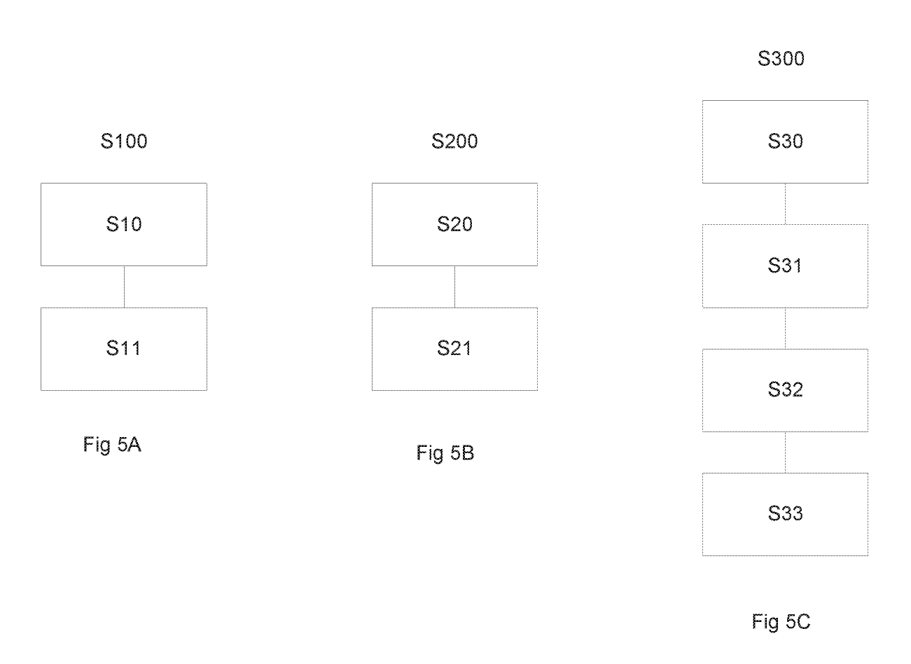

According to one aspect, a computer program product comprising a non-transitory computer readable medium, having thereon a computer program comprising program instructions S100 is provided. The computer program being loadable into a data processing unit configured to, when the computer program is run by the data processing unit, cause execution of the steps of, as shown in FIG. 5A, splitting (S10) a single stream of data into multiple streams of data, wherein each of the multiple streams of data is a subset or an exact or a complete copy of the single stream of data and transmitting (S11) the multiple streams of data over at least two different wired and/or wireless communication channels 13, 17 at the same time, wherein each of the multiple streams of data is transmitted over a corresponding one of the at least two different wired and/or wireless communication channels. Each of the at least two different wired and/or wireless communication channels are configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

According to one aspect, a computer program product comprising a non-transitory computer readable medium, having thereon a computer program comprising program instructions S200 is provided. The computer program being loadable into a data processing unit configured to, when the computer program is run by the data processing unit, cause execution of the steps of, as shown in FIG. 5B, receiving (S20) multiple streams of data over at least two different wired and/or wireless communication channels 13, 17 at the same time, wherein each of the multiple streams of data is received over a corresponding one of the at least two different wired and/or wireless communication channels and wherein each of the at least two different wired and/or wireless communication channels are configured according to different data transmitting technologies and assembling (S21) the multiple streams of data into one single stream of data. Each of the multiple streams of data is a subset or an exact or a complete copy of a single stream of data. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency

According to one aspect, a computer program product comprising a non-transitory computer readable medium, having thereon a computer program comprising program instructions S300. The computer program being loadable into a data processing unit configured to, when the computer program is run by the data processing unit, cause execution of the steps of, as shown in FIG. 5C, receiving (S30) multiple streams of data, wherein each one of the multiple streams of data is a subset or an exact or a complete copy of a single stream of data, analysing (S31) an availability for transmission of at least one of the multiple streams of data over each one of the different wired and/or wireless communication channels 13, selecting (S32) at least two different wired and/or wireless communication channels 13 which are determined as available and transmitting (S33) each of the received streams of data over the selected at least two different wired and/or wireless communication channels 13, wherein each of the multiple streams of data is transmitted over a corresponding one of the at least two different wired and/or wireless communication channels. Each different wired and/or wireless communication channel is configured according to different data transmitting technologies. The at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

Several ways of communication connections are shown in FIGS. 1-4.

In one example, a stream of data 11, 12 is transmitted to and/or from a user equipment, UE, 20, 21 with requirement of low latency and high reliability. The stream of data is denoted by 11 when entering the system and is denoted by 12 when exiting the system. The stream of data is sent into 12 will exit at 11 (i.e. bidirectional streams of data).

In one example, a stream of data is denoted 13 when transferred over multiple wired and/or wireless communication channels between the module denoted 2 and the server 4. The communication is started by the connected UE 20.

In one example, a stream of data is denoted 14 when transferred over a single wired and/or wireless communication channel between the server 4 and the module denoted 3. The communication is started by the software application included in a remote communication device 21.

In one example, a generic data stream is denoted 15, 16 when transferred over a single wired and/or wireless communication channel to and/or from a user equipment, UE, 20, 21. The data needs high bandwidth and losses are tolerated (i.e. some latency is acceptable). An example of this is real-time video streaming. The stream of data is denoted by 15 when entering the system and is denoted 16 when exiting the system. The stream of data sent into 16 will exit at 15.

In one example, the stream of data is denoted 17 when transferred directly between the connected hardware 20 and the connected software application comprised in a remote communication device 21. The connected hardware 20 can use all available communication methods to transmit data. It can be spread between the different wired and/or wireless communication channels depending on the performance and/or the quality of each communication channel.

According to an aspect, a firewall 9, 10 is provided within the system. The firewall can be handled by the Internet Service provider and/or by the operating system of the hardware. In one example all incoming streams of data will be blocked and to bypass this (e.g. a firewall) there is a need for deploying a hole punching mechanism, for example UDP hole punching, were the server 4 will assist. A coordinator channel 18, 19 can control the multiplexor/demultiplexor 7, 8 to assist in the hole punching for the connected hardware 20 and/or the connected software comprised in the remote communication device 21 and to direct how the stream of data should be spread over the multiple wired and/or wireless communication channels.

According to an aspect, the module further comprise a communication interface 30, as shown in FIGS. 1 and 4, configured to communicate with at least one remote entity over a communication network 1.

In one example, the communication network 1 is a standardized wireless local area network such as a Wireless Local Area Network, WLAN, Bluetooth™, ZigBee, Ultra-Wideband, Near Field Communication, NFC, Radio Frequency Identification, RFID, or similar network. In one example the communication network 1 is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network. The communication network 1 can also be a combination of both a local area network and a wide area network. The communication network 1 can also be a wired network. According to some aspects of the disclosure the communication network 1 is defined by common Internet Protocols.

The communication interface 30 may comprise any number of transceiving, receiving, and/or transmitting units or circuitry. According to some aspects the communication interface 30 is a radio communication interface. The radio communication interface 30 may be in the form of any input/output communications port known in the art. The radio communication interface 30 may comprise RF circuitry and baseband processing circuitry. The radio communication interface 30 may support either wireless and/or wired communication.

A “user equipment” as the term may be used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

According to some aspects, the communication between the modules 2, 3 and the UE, 20, 21 is encrypted. The communication between the modules 2, 3 and the UE, 20, 21 is for example encrypted using Secure Sockets Layer, SSL, or Transport Layer Security, TLS. SSL uses a combination of encryption using public keys and symmetrical keys. SSL may use several different methods of encryption, such as Data Encryption Standard, DES, Digital Signature Algorithm, DSA, Key Exchange Algorithm, KEA, Message-Digest algorithm 5, MD5, Rivest Cipher 2, RC2, Rivest Cipher4, RC4, Rivest, Shamir and Adleman encryption, RSA, Secure Hash Algorithm, SHA-1, SKIPJACK or Triple Data Encryption Standard, Triple-DES.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims.

In the drawings and specification, there have been disclosed exemplary aspects. However, many variations and modifications can be made to these aspects. Accordingly, although specific terms are employed, they are used in a generic and descriptive sense only and not for purposes of limitation, the scope of the embodiments being defined by the following claims.

I claim:

1. A data stream handler module configured to cause transmission of a single stream of data over multiple wired and/or wireless communication channels between a hardware unit and a software application comprised in a remote communication device, wherein the data stream handler module comprises:
a. a multiplexor configured to split the single stream of data into multiple streams of data, wherein each of the multiple streams of data is a subset or an exact or a complete copy of the single stream of data; and
b. a processor configured to cause transmission of the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

2. A data stream handler module configured to cause reception of multiple streams of data over multiple wired and/or wireless communication channels between a hardware unit and a software application comprised in a remote communication device, wherein the data stream handler module comprises:
a. a processor configured to cause reception of the multiple streams of data over at least two different wired and/or wireless communication channels at the same time, wherein each of the multiple streams of data is received over a corresponding one of the at least two different wired and/or wireless communication channels and wherein each of the at least two different wired and/or wireless communication channels are configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency; and
b. a demultiplexor configured to assemble the multiple streams of data into one single stream of data, wherein each of the multiple streams of data is a subset or an exact or a complete copy of the single stream of data.

3. A data stream handler module configured to cause transmission of a single stream of data over multiple wired and/or wireless communication channels between a hardware unit and a software application comprised in a remote communication device and reception of multiple streams of data over multiple wired and/or wireless communication channels between a hardware unit and a software application comprised in a remote communication device, wherein the data stream handler module comprises:
a. a multiplexor configured to split the single stream of data to be transmitted into multiple streams of data, wherein each of the multiple streams of data is a subset or an exact or a complete copy of the single stream of data;
b. a demultiplexor configured to assemble the received multiple streams of data into the single stream of data, wherein each of the multiple streams of data is a subset or an exact or a complete copy of one of the single stream of data; and
c. a processor configured to:
i. cause transmission of the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies; and
ii. cause reception of the multiple streams of data over at least two different wired and/or wireless communication channels at the same time, wherein each of the multiple streams of data is received over a corresponding one of the at least two different wired and/or wireless communication channels and wherein each of the at least two different wired and/or wireless communication channels are configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

4. The module according to claim 1, wherein the data comprises data packages.

5. The module according to claim 1, wherein the multiplexor is further configured to set a time stamp on each data package and wherein the demultiplexor is further configured to read the time stamp on each data package in order to determine latency or jitter.

6. The module according to claim 1, wherein the processor is further configured to cause an information exchange with another processor of another data stream handler module wherein the information exchange comprises monitoring information on quality of the at least two different wired and/or wireless communication channels.

7. The module according to claim 1, wherein at least one of the data transmitting technologies comprises radio access technology defined in accordance with a radio access technology standard.

8. The module according to claim 1, wherein the module is included in the hardware unit and/or in a server and/or in the remote communication device.

9. A server for handling multiple streams of data over at least two different wired and/or wireless communication channels at the same time configured to:
a. receive the multiple streams of data, wherein each one of the multiple streams of data is a subset or an exact or a complete copy of a single stream of data;
b. analyse the availability for transmission of at least one of the multiple streams of data over each one of the different wired and/or wireless communication channels;
c. select at least two different wired and/or wireless communication channels which are determined as available; and
d. transmit each of the received streams of data over the selected at least two different wired and/or wireless communication channels, wherein each of the multiple streams of data is transmitted over a corresponding one of the at least two different wired and/or wireless communication channels;
wherein each different wired and/or wireless communication channel is configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

10. The server according to claim 9, wherein the data comprises data packages.

11. The server according to claim 9, wherein the server is further configured to comprise a module comprising multiplexors/demultiplexors and processor.

12. The server according to claim 9, wherein at least one of the data transmitting technologies comprises a radio access technology defined in accordance with a radio access technology standard.

13. A computer program product comprising a non-transitory computer readable medium, having thereon a computer program comprising program instructions, the computer program being loadable into a data processing unit configured to, when the computer program is run by the data processing unit, cause execution of the steps of:
a. splitting a single stream of data into multiple streams of data, wherein each of the multiple streams of data is a subset or an exact or a complete copy of the single stream of data; and
b. transmitting the multiple streams of data over at least two different wired and/or wireless communication channels at the same time, wherein each of the multiple streams of data is transmitted over a corresponding one of the at least two different wired and/or wireless communication channels and wherein each of the at least two different wired and/or wireless communication channels are configured according to different data transmitting technologies, and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

14. A computer program product comprising a non-transitory computer readable medium, having thereon a computer program comprising program instructions, the computer program being loadable into a data processing unit configured to, when the computer program is run by the data processing unit, cause execution of the steps of:
a. receiving multiple streams of data over at least two different wired and/or wireless communication channels at the same time, wherein each of the multiple streams of data is received over a corresponding one of the at least two different wired and/or wireless communication channels and wherein each of the at least two different wired and/or wireless communication channels are configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency; and
b. assembling the multiple streams of data into one single stream of data, wherein each of the multiple streams of data is a subset or an exact or a complete copy of one of the single stream of data.

15. A computer program product comprising a non-transitory computer readable medium, having thereon a computer program comprising program instructions, the computer program being loadable into a data processing unit configured to, when the computer program is run by the data processing unit, cause execution of the steps of:
a. receiving multiple streams of data, wherein each one of the multiple streams of data is a subset or an exact or a complete copy of a single stream of data;
b. analysing an availability for transmission of at least one of the multiple streams of data over each one of different wired and/or wireless communication channels;
c. selecting at least two different wired and/or wireless communication channels which are determined as available; and
d. transmitting each of the received multiple streams of data over the selected at least two different wired and/or wireless communication channels, wherein each of the multiple streams of data is transmitted over a corresponding one of the at least two different wired and/or wireless communication channels and wherein each different wired and/or wireless communication channel is configured according to different data transmitting technologies and wherein each of the at least two different wired and/or wireless communication channels are continuously monitored on quality and selected/re-selected to carry the stream of data depending on the monitored quality or a predicted quality of the at least two different wired and/or wireless communication channels wherein the monitoring of quality comprises monitoring signal strength, packet loss, transmission speed, jitter or latency.

16. The computer program product according to claim 13, wherein the data comprises data packages.
